(19) United States
(12) Patent Application Publication
(10) Pub. No.: US 2009/0261575 A1
(43) Pub. Date: Oct. 22, 2009

(54) Adjustable Length Discharge Joint for High Pressure Applications

(75) Inventors: Brad Bull, Duncan, OK (US); William D. Kendrick, Duncan, OK (US)

Correspondence Address: JOHN W. WUSTENBERG, P.O. BOX 1431, DUNCAN, OK, 73536, US

(73) Assignee: Halliburton Energy Services Inc., Houston, TX (US)

(21) Appl. No.: 12/107,714

(22) Filed: Apr. 22, 2008

(51) Int. Cl. F16L 15/02; F16L 27/12; B23P 11/00

(52) U.S. Cl. 285/32; 285/302; 285/119; 29/428

(57) ABSTRACT

An adjustable length joint for high-pressure applications is described that includes rigid inner and outer tubes; both having passages there through. The rigid outer tube has at least one peripheral ring groove within its inner wall. The tubes have threads, which are adapted to adjustably engage with one another securely at a working pressure of at least about 10,000 psi. The rigid inner tube and the rigid outer tube are rotatable to enable adjustable engagement between the threads. The joint also includes an O-ring seated in each of the at least one peripheral ring grooves. When the rigid inner tube and the rigid outer tube are held in a selectable position, the first thread and the second thread overlap a sufficient distance necessary for the first thread and the second thread to withstand the forces exerted by the internal pressure within the joint at the working pressure.

### BACKGROUND

This invention relates generally to adjustable length discharge joint assemblies and more particularly, but not by way of limitation, to adjustable length discharge joints suitable for high-pressure connections or installations where tolerance stack up is an issue.

At a site where an oil or gas well has been drilled, there is often the need for conveying substances at high pressure, i.e. 10,000-20,000 pounds per square inch (“psi”), between two fixed components within the fluid delivery installation, which are spaced at different distances and orientations relative to each other at a well site. Assemblies having parallel-connected rigid interconnections were developed to facilitate the delivery of these fluids under high-pressure. These rigid interconnections facilitate relatively rapid fluid delivery while allowing easily controllable shutoff should a portion of the installation be damaged or require maintenance. What these installations lack, however, is a way to compensate for the differences in distances and orientations between the various components within the installation.

When possible, a sufficient number of swivel joints and elbows are used to allow full adjustment between two fixed components. However, in many applications the added weight and area required for these connections is prohibitive. In these situations, the size and orientation of the components within the installation must be adjusted. The adjustments are typically done on site, i.e. boat, offshore skid, or tool external bypass lines, since the exact orientation of the installations vary from site to site. This significantly slows down the fabrication and assembly of the installation, and results in the loss of significant amounts of time, labor, and financial resources.

### BRIEF SUMMARY OF THE INVENTION

Accordingly there is disclosed herein an adjustable length straight discharge joint, which is adapted for use in high-pressure connections. The ability to adjust the length of a high-pressure connection allows a fixed installation to be made up when space or weight restrictions would not allow swivel joints to give enough degrees of freedom between components. When the disclosed apparatus is employed, fabrication and assembly of fixed high-pressure assemblies will be much easier and quicker, as the tolerance stack up will be of less concern.

Some of the disclosed embodiments provide an adjustable length discharge joint for high-pressure fluid delivery installations is provided that includes a rigid outer tube, a rigid inner tube, at least one adjustment limiter in operational contact with at least one of the rigid inner tube, the rigid outer tube, or both, at least one recess adapted to allow adjustment of the selectable position, which is defined by the inner wall of the rigid outer tube and the outer wall of the rigid inner tube, and an O-ring seated in each of the at least one peripheral ring grooves disposed about the inner wall of the rigid outer tube. The rigid outer tube has a first end, central portion, and a second end, with an inner wall defining a first cylindrical passage extending from the first end to the second end. The rigid outer tube has at least one peripheral ring groove within its inner wall. Each peripheral ring groove is disposed about the second end of the rigid outer tube. The inner wall has a first thread defined thereon, which is disposed about the central portion of the rigid outer tube. The second end of the rigid outer tube has a connector to connect the joint to a next component within the installation. The rigid inner tube has a first end, central portion, and a second end. The rigid inner tube has an inner wall defining a second cylindrical passage extending from the first end to the second end and an outer wall with a second thread defined thereon, which is adapted to securely engage with the first thread such that the rigid inner tube is securely engaged in a selectable position relative to the rigid outer tube at a working pressure in the range of at least about 10,000 psi. The rigid inner tube and the rigid outer tube are rotatable to enable adjustable engagement between the first thread and second thread. The outer wall has an O-ring sealing surface thereupon. The first end of the rigid inner tube has a connector to connect to a next component within the high-pressure installation. The adjustment limiter is integral to the rigid outer tube. The joint also includes at least one recess adapted to allow adjustment of the selectable position. The inner wall of the rigid outer tube and the outer wall of the rigid inner tube define the recess. The joint also includes an O-ring seated in each of the at least one peripheral ring grooves. When the rigid inner tube and the rigid outer tube are held in the selectable position, the first thread and the second thread overlap a sufficient distance necessary for the first thread and second thread to withstand the forces exerted by internal pressure within the joint at the working pressure.

Other disclosed embodiments provide an adjustable length discharge joint for high-pressure fluid delivery installations that includes a rigid outer tube that has a first end, central portion, and a second end. The rigid outer tube has an inner wall defining a first cylindrical passage that extends from the first end to the second end. The rigid outer tube has at least one peripheral ring groove within the inner wall that is disposed about the second end of the rigid outer tube. The inner wall has a first thread defined thereon, which is disposed about the central portion of the rigid outer tube. The joint also includes a high-pressure connector to connect to a next component within the installation; the connection means being disposed about the second end of the rigid outer tube. The rigid inner tube has a first end, central portion, and a second end. The rigid inner tube has an inner wall defining a second cylindrical passage that extends from the first end to the second end. The rigid inner tube has an outer wall for communicating with the first cylindrical passage, the outer wall having a second thread defined thereon. The first thread and second thread are adapted to securely engage with one another such that the rigid inner tube is securely engaged in a selectable position relative to the rigid outer tube at a working pressure of about 15,000 psi. The rigid inner tube and outer tube are rotatable to enable adjustable engagement between the first and second threads. The outer wall of the rigid inner tube has an O-ring sealing surface thereupon. The discharge joint further includes a high-pressure connector to connect to a next component within the high-pressure installation disposed about the first end of the rigid inner tube. The discharge joint also includes at least one adjustment limiter for limiting the adjustment of the selectable position within the discharge joint. The means comprises at least one of a setscrew, stop, screw, pin, shoulder or a visual marking on the assembly. The joint also includes a backup ring and an O-ring seated in each of the peripheral ring grooves. When the rigid inner tube and the rigid outer tube are held in a selectable position, the first and second threads overlap a sufficient distance necessary for the first thread and the second thread to withstand the forces exerted by internal pressure within the joint at the working pressure.

Still other embodiments provide an adjustable length discharge joint for a high-pressure fluid delivery installation that includes a rigid outer tube that has a first end, central portion, and a second end. The rigid outer tube has an inner wall that defines a first cylindrical passage that extends from the first end to the second end and at least one peripheral ring groove within its inner wall. The groove is disposed about the second end of the rigid outer tube. The rigid outer tube has a first thread defined thereon, which is disposed about the central portion of its inner wall. The second end of the rigid outer tube has a high-pressure connector to connect to a next component within the high-pressure installation. The high-pressure connection means is a female thread and further includes a seal ring that is removably disposed about the female thread. The joint also includes a rigid inner tube that has a first end, a central portion and a second end. The rigid inner tube has an inner wall that defines a second cylindrical passage that extends from the first end to the second end. The rigid inner tube has an outer wall for communicating with the first cylindrical passage. The outer wall of the rigid inner tube has a second thread defined thereon, which is adapted to securely engage with the first thread of the rigid outer tube such that the rigid inner tube is securely engaged in a selectable position relative to the rigid outer tube at a working pressure of about 15,000 psi. The rigid inner tube and rigid outer tube are rotatable to enable adjustable engagement between the first and second threads in the selectable position. The rigid outer tube has an O-ring sealing surface thereupon. The first end of the rigid inner tube has a high-pressure connector to connect to a next assembly. The connection means includes a male thread. The joint further includes at least one recess for collecting debris in either the inner wall of the rigid outer tube or the outer wall of the rigid inner tube. The joint further includes an adjustment limiter for limiting the adjustment of the selectable position in operational contact with at least one of the rigid inner tube, the rigid outer tube, or both, which is adapted to define or limit the range of adjustment to ±0.5 inches. The means includes a setscrew, and an aperture that includes a tapped thread and extends through the inner and outer walls of the rigid outer tube. The aperture is for engagement by the setscrew. The means also includes a channel defined by the outer walls of the rigid inner tube, which is adapted to engage the setscrew thereby defining a range of adjustment of the selectable position. The joint further includes at least one recess, which is in place to allow adjustment of the selectable position. The inner wall of the rigid outer tube and the outer wall of the rigid inner tube define the recess. The joint also includes a backup ring and an O-ring seated in each of the peripheral ring grooves, a bleed port about the rigid outer tube, and at least one recess within the inner wall of the rigid outer tube for the collection of debris and an O-ring seated in each of the peripheral ring grooves. When the inner and outer tubes are held in a selectable position, the first and second threads are adapted to overlap a sufficient distance necessary for the first thread and the second thread to withstand the forces exerted by internal pressure within the joint at the working pressure.

A method of manufacturing an adjustable length joint for high-pressure installations is also provided that includes machining a rigid outer tube having a first end, central portion, and a second end, the rigid outer tube having an inner wall defining a first passage extending from the first end to the second end, the outer tube having two peripheral ring grooves within the inner wall, which are disposed about the second end of the rigid outer tube. The inner wall has a first thread defined thereon, which is disposed about the central portion of the rigid outer tube, and the second end has a high pressure connector for connecting to a next component within the high-pressure installation, the high pressure connector being a female thread. The method also includes machining a rigid inner tube having a first end, central portion, second end, an inner wall defining a second passage extending from the first end to the second end, and an outer wall for communicating with said first passage. The outer wall has a second thread defined thereon, which is adapted to securely engage with the first thread such that the rigid inner tube is securely engaged in a selectable position relative to the rigid outer tube at a working pressure of about 15,000 psi. The rigid inner tube and the rigid outer tube are rotatable to enable adjustable engagement between the first thread and the second thread in the selectable position, and the outer wall having an O-ring sealing surface thereupon. The first end of the rigid inner tube has a high pressure connector for connecting to a next component within the high-pressure installation, which includes a male thread. The method further includes threading the rigid inner tube into the rigid outer tube to engage the first and second threads with an overlap of a sufficient distance necessary for the threads to withstand the forces exerted by the internal pressure within the joint at the working pressure. A set screw is also placed into an aperture that extends through the outer wall of the rigid outer tube to engage a channel defined by the outer wall of the rigid inner tube, thereby defining a range of adjustment for the selectable position of ±0.5 inches.

Therefore, the disclosed embodiments may advantageously provide a novel adjustable length discharge joint for high-pressure applications that may be successfully employed in situations where space or weight restrictions would not allow swivel joints to give enough degrees of freedom between components and in situations where tolerance stack up is an issue. The above and other features of this invention will be fully understood from the following description and the accompanying drawings.

### BRIEF DESCRIPTION OF THE SEVERAL VIEWS OF THE DRAWINGS

FIG. 1 is a side view of a novel adjustable length discharge joint for high pressure applications shown within a high pressure installation;

FIG. 2 is a cross-sectional view of one embodiment illustrating the joint secured in a selectable position;

FIG. 3 is a cross-sectional view of a specific embodiment, wherein a set screw is employed to limit the adjustment of the selectable position;

FIG. 4 is a cross-sectional view of one embodiment of the rigid outer tube of the invention;

FIG. 5 is a plan view of one embodiment of the rigid outer tube of the invention;

FIG. 6 is a cross-sectional view of one embodiment of the rigid inner tube of the invention; and

FIG. 7 is a plan view of one embodiment of the rigid inner tube of the invention

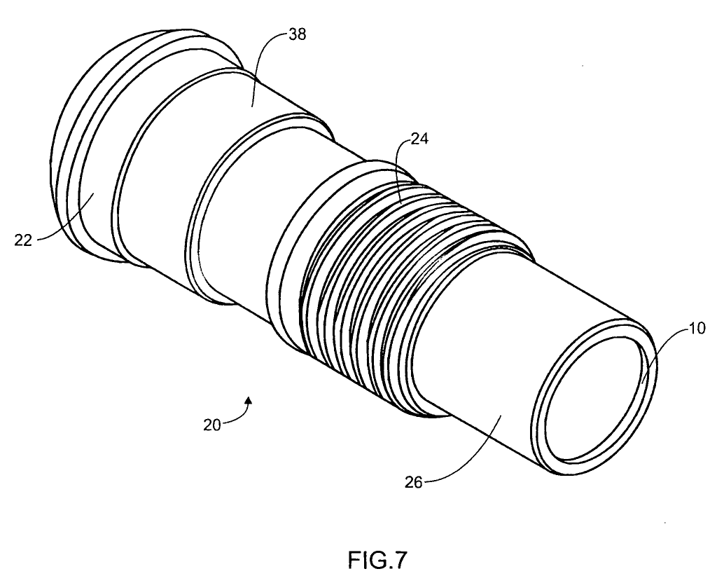

### DETAILED DESCRIPTION

While adjustable joint assemblies have been designed for connecting rigid components within low-pressure fluid delivery installations, e.g. up to approximately 500 psi, no apparatus currently exists for successfully connecting rigid components within high-pressure installations where space and weight may be an issue and tolerance stack up can cause binding and sealing problems. Adjustable installations designed for low-pressure fluid delivery assemblies are generally not sufficient to withstand the radial and axial forces within high-pressure installations. Seal design, wall thickness, end connection, and material selection are all dependent on the pressure rating. As such, assemblies designed for lower pressure installations would fail from any of these criteria when used in high-pressure environments. As such, a need still exists for an adjustable length joint for high-pressure applications.

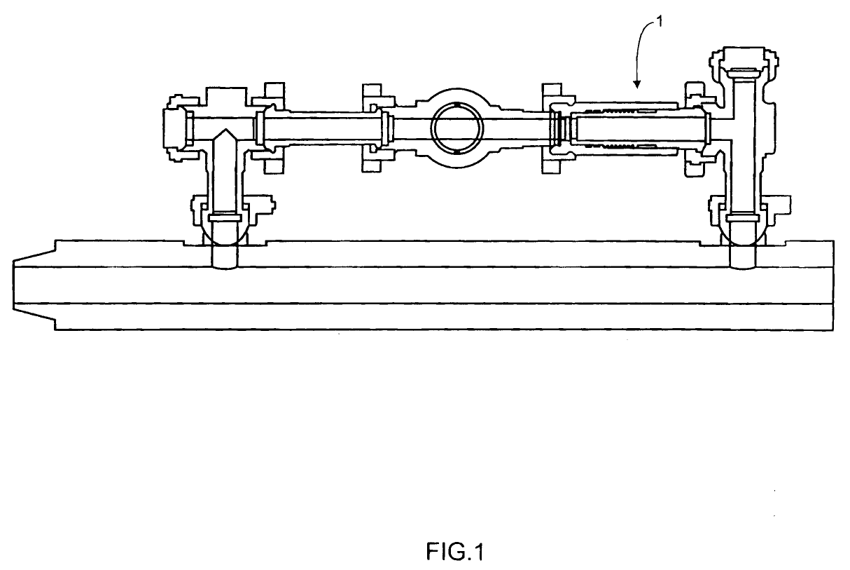

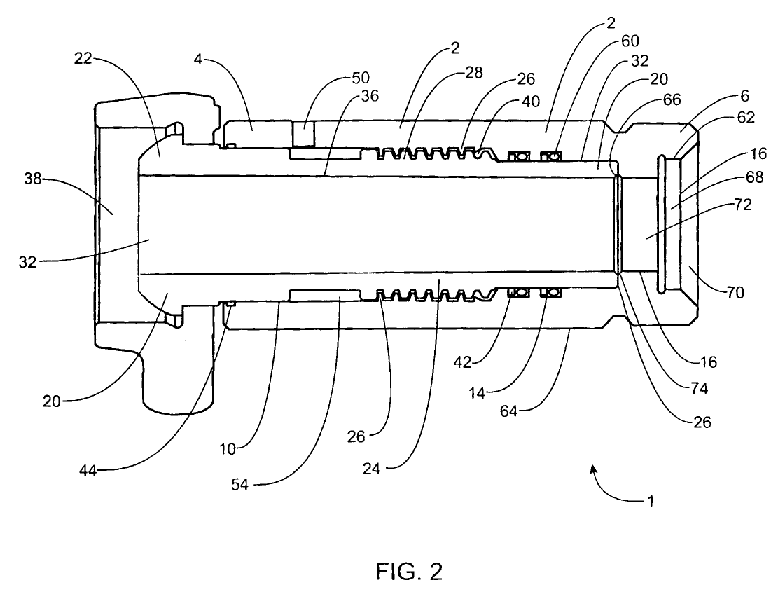

With reference to FIG. 1, the environment in which the illustrated embodiments of the invention described herein are to be used includes that found at a well site wherein rigid high-pressure connections are being employed within fluid delivery installations, e.g. a tool bypass line that allows fluid flow around a tool or other temporary obstruction of a pipeline. FIG. 1 illustrates the placement of joint 1 within such a tool bypass line. As used herein, the term “high-pressure” refers to pressures of at least 10,000 psi. It is to be noted that the adjustable length joint 1 provides a rigid connection between two components within a high-pressure installation, which have a fixed location or orientation. Joint 1 is adjustable to accommodate for different distances and orientations between the two components. The length of joint 1 is adapted to be adjusted to a selectable position by rotating rigid outer tube 2, rigid inner tube 20, or both, as discussed in more detail below. As used herein, the phrase “selectable position” means the relative position between rigid inner tube 20 and rigid outer tube 2 selected by a user to compensate for the orientation of, or distance between, two fixed components within a high-pressure fluid delivery installation. FIG. 2 illustrates joint 1 secured in a selectable position.

As illustrated in FIG. 1, joint 1 is meant to adjustably connect fixed components within a high-pressure fluid delivery installation. As such, first end 22 of rigid inner tube 20 and second end 6 of rigid outer tube 2 each have a connector 16, 38 thereupon for connecting to a next component. The assemblies illustrated in the figures are merely examples and are not meant to limit the components that may be connected to joint 1. The illustrations are provided to illustrate the fact that joint 1 is adapted to be installed in a piping installation by being structurally interconnected to other fixed components within that installation. Examples of components that may be adjustably connected to joint 1 of the invention include, but are not limited to H-manifolds, squeeze manifolds, marine installations, offshore skid installations and tool bypass lines (as illustrated in FIG. 1).

With reference to FIG. 2, the illustrated embodiment is an adjustable length joint 1 for a high-pressure installation that includes a rigid outer tube 2, a rigid inner tube 20 having at least one peripheral ring groove 14, at least one adjustment limiter in operational contact with at least one of rigid inner tube 20, rigid outer tube 2, or both, at least one recess 40 adapted to allow adjustment of the selectable position and an O-ring 60 seated in each of the at least one peripheral ring grooves 14. As used herein, “operational contact” means the minimal amount of contact necessary for two components to function cooperatively with each another. As any skilled artisan would appreciate, components or elements of the invention do not necessarily need to be in physical contact to be in operational contact.

Rigid outer tube 2 and rigid inner tube 20 may be made of any material suitable for use in high-pressure fluid delivery installations. Those of skill in the art know these materials. One example of a suitable material is steel. In particular embodiments joint 1 is made of steel that is quenched and tempered. In other particular embodiments joint 1 is made of stainless steel that is age-hardened. In still other embodiments, rigid outer tube 2 and rigid inner tube 20 are made of different materials, including but not limited to 4340 steel and 17-4 stainless steel.

Rigid outer tube 2 has a first end 4, central portion 8, and a second end 6. First end 4 of the rigid outer tube 2 is adapted to engage with at least a portion of first end 22 of the rigid inner tube 20. The central portion 8 is adapted to adjustably engage with rigid inner tube 20. Second end 6 is adapted to connect with a next component within the high-pressure fluid delivery installation. Rigid outer tube 2 has an inner wall 10 that defines a first passage 12 that extends from the first end 4 to the second end 6. First passage 12 is adapted to engage with rigid inner tube 20.

In particular embodiments inner wall 10 has a thickness of about 0.855 inches. It will be appreciated by those skilled in the art, that the thickness of inner wall 10 varies between its first end 4 and its second end 6.

In particular embodiments, the distance between first end 4 and second end 6 is about 9.75 inches. The inner diameter of first passage 12 is about 2.539 inches when measured about its second end 6 and an outer diameter of about 4.25 when measured about its second end 6. Again, one skilled in the art will appreciate that the outer diameter of rigid outer tube 2 varies along the length of rigid outer tube 2.

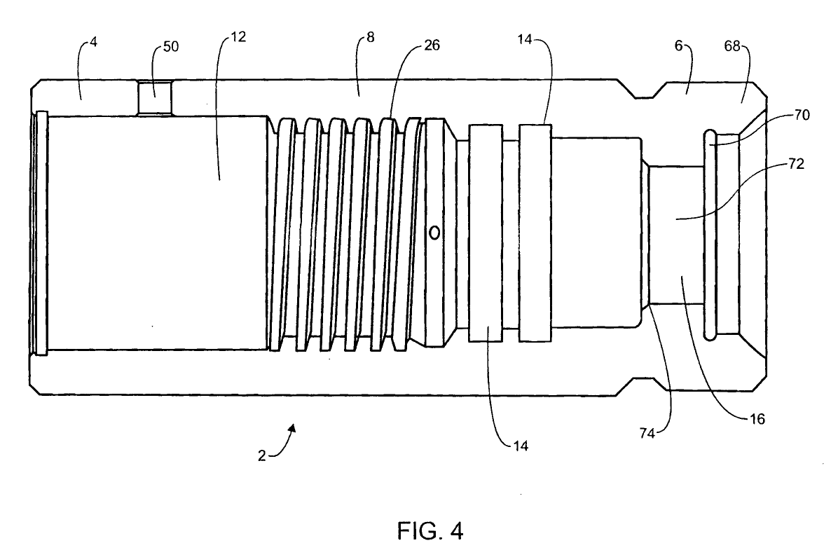

Rigid outer tube 2 has at least one peripheral ring groove 14 within its inner wall 10. At least one peripheral ring groove 14 is disposed about second end 6 of the rigid outer tube 2. Inner wall 10 has a first thread 26 (FIG. 4) defined thereon, which is disposed about the central portion 8 of the rigid outer tube 2. Second end 6 of rigid outer tube 2 has a connector 16 for connecting the joint 1 to a next assembly.

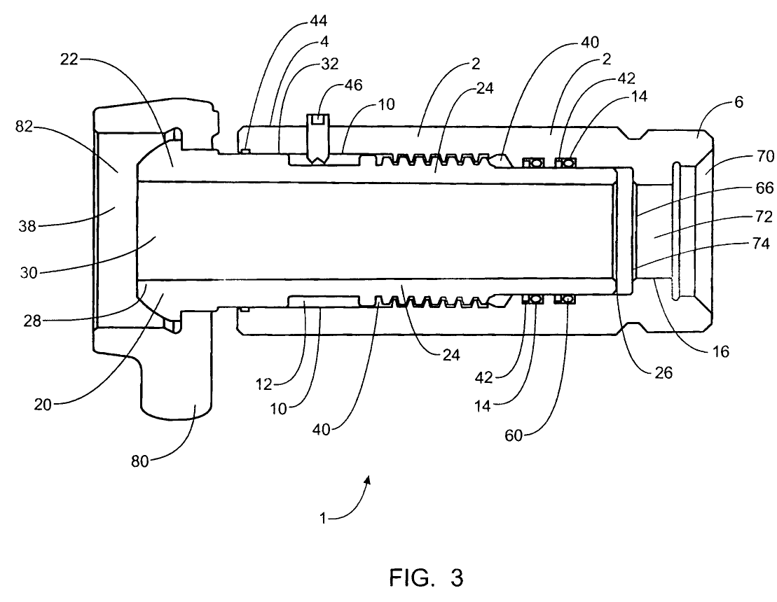

In one particular embodiment, joint 1 includes one peripheral ring groove 14 and one O-ring 60 seated therein. In another embodiment, joint 1 includes two peripheral ring grooves 14, and accordingly, two O-rings 42 seated therein. The use of multiple O-rings 42 ensures a fluid-tight seal, and is generally adequate to prevent failure of the seal at the working pressure. Peripheral ring grooves 14, as illustrated in FIGS. 2 and 3, are generally not tapered. Each groove 14 includes a bottom wall and two sidewalls, which are generally parallel to each other and perpendicular to the bottom wall. It should be noted that the exact shape of the ring grooves 14 is not critical. Any ring groove 14 that is capable of creating a fluid-type seal within the joint 1, when an O-ring 60 is seated therein may be employed. Peripheral ring groove 14 is capable of maintaining a fluid tight seal in the high-pressure environment for which this invention is contemplated to be used.

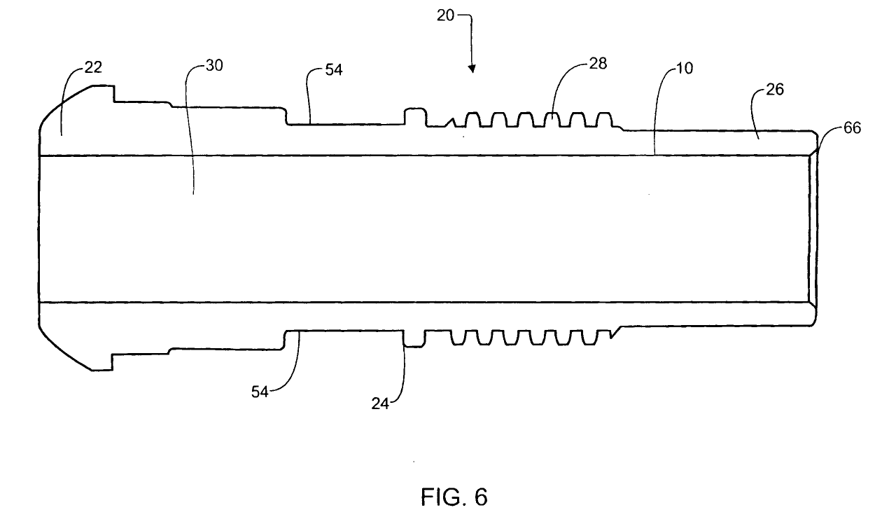

Rigid inner tube 20 includes a first end 22, central portion 24, and a second end 26. First end 22 is adapted to connect with a next component within a high-pressure fluid delivery installation. Central portion 24 is adapted to adjustably engage with rigid outer tube 2. Second end 26 is adapted to engage with the inner wall 10 of rigid outer tube 2. Rigid inner tube 20 includes an inner wall 28 defining a second passage 30 that extends from first end 22 to second end 26. Rigid inner tube 20 has an outer wall 32 for communicating with the first passage 12 of rigid outer tube 2. To enable adjustable communication between rigid inner tube 20 and rigid outer tube 2, outer wall 32 of rigid inner tube 20 has a diameter that is less than the inner diameter of rigid outer tube 2. Outer wall 32 of rigid inner tube 20 has a second thread 28 (FIG. 6) defined thereon for communication with first thread 26 disposed on the inner wall of rigid outer tube 2. Rigid inner tube 20 further includes a connector 38 for connecting joint 1 of the invention to a next component within a high-pressure installation. The connector 38 lies about its first end.

In particular embodiments, rigid inner tube 20 has a wall thickness of about 0.325 inches, when measured about its second end 26. As those skilled in the art will appreciate, the wall thickness of rigid inner tube 20 varies when measured about the length of the outer wall 32.

In particular embodiments, rigid inner tube 20 has a length of about 9.85 inches when measured from first end 22 to second end 26. The inner diameter of rigid inner tube 20 is about 1.88 inches when measured about its second end 26. The outer diameter is about 2.53 inches when measured about its second end.

As illustrated in FIG. 3, when in a selectable position, a portion of first end 4 of rigid outer tube 2 must be in contact with a portion of first end 22 of rigid inner tube 20, and a portion of second end 6 of rigid outer tube 2 is in contact with a portion of second end 26 of rigid inner tube 20. First thread 26 and second thread 28 are securely engaged with one another such that rigid inner tube 20 is securely engaged in a selectable position to rigid outer tube 2 at a working pressure of at least about 10,000 psi. As used herein, “secure engagement” means that first thread 26 and second thread 28 will remain in physical contact with one another when subject to the internal forces present within joint 1 at the working pressure. Joint 1 does not require the use of clamps, nuts, rings, bolts, yokes, collars, or the like. These devices were employed to further strengthen the adjustable mechanisms to allow them to withstand the forces present within the fluid delivery installation. First thread 26 and second thread 28, when securely engaged, are independently capable of withstanding the maximum internal forces present at the working pressure without failure. In one embodiment, the maximum working pressure is at least about 10,000 psi. In another embodiment, the maximum working pressure is about 15,000 psi. In yet another embodiment, the maximum working pressure is in the range of about 10,000-20,000 psi.

Rigid inner tube 20 and rigid outer tube 2 are each rotatable to enable adjustable engagement between rigid inner tube 20 and rigid outer tube 2. When in a selectable position, the range of adjustment is limited to about one inch. More specifically, the illustrated joint 1 may be lengthened by ±0.5 inches. While greater adjustment, i.e. lengthening or shortening of joint 1 is possible, secure engagement is only possible when at least a minimum amount of overlap occurs between first thread 26 and second thread 28. It has been discovered that a minimum overlap of about one inch between first thread 26 and second thread 28 is necessary for the threads to be securely engaged at a working pressure of about 15,000 psi. As one skilled in the art would appreciate, the amount of overlap necessary for secure engagement between first thread 26 and second thread 28 varies depending on the working pressure present within the particular installation. Prior art devices that allow greater ranges of adjustment are generally not strong enough to withstand the forces exerted in high-pressure installations. To adjust the length of the joint 1, rigid inner tube 20, rigid outer tube 2, or both, is rotated. Rotation in one direction lengthens joint 1, and rotation in the opposite direction shortens joint 1. In some particular embodiments, the first and second threads are Acme threads. In more particular embodiments of the invention at least one of first thread 26 and/or second thread 28 are 1502 threads, which are readily machined with commercially available taps.

To ensure that first thread 26 and second thread 28 remain in a secure position during use, joint 1 includes at least one adjustment limiter in operational contact with at least one of rigid inner tube 20, rigid outer tube 2, or both. The adjustment limiter may be any mechanism or indicator capable of limiting the amount of contact between first thread 26 and second thread 28. The adjustment limiter prevents rotation of rigid inner tube 20, rigid outer tube 2, or both past a pre-selected stopping point. The stopping point is determined based on the minimal amount of overlap required for first thread 26 and second thread 28 to remain securely engaged during use at the maximum working pressure. In various alternative embodiments, the means 46 for limiting the adjustment of the selectable position includes, but is not limited to a setscrew 52 (shown in FIG. 3), stop, pin, shoulder, or a visual marking on joint 1.

In a specific embodiment illustrated in FIG. 3, the adjustment limiter 46 includes a setscrew 52, an aperture 50 extending through the inner wall 10 and outer wall 64 of rigid outer tube 2 for engagement by the setscrew 52, and a channel 54 (FIG. 6) defined by outer walls 32 of rigid inner tube 20. Channel 54 is adapted to engage a setscrew (FIG. 3), thereby defining a range of adjustment for the selectable position.

Limiting the range of adjustment for the selectable position is of paramount importance because a minimum amount of overlap between rigid outer tube 2 and rigid inner tubes 20 is desirable to allow the joint to withstand the axial forces exerted internally in a high-pressure installation. It has been found that rigid inner tube 20 and rigid outer tube 2 must overlap at least one inch in order for the installation to withstand the maximum axial forces present at a working pressure of 10,000 psi (test pressure of 15,000 psi). This enables first thread 26 and second thread 28 to withstand about 150,000 pounds of force at a working pressure of 15,000 psi (test pressure of 22,500 psi) and about 100,000 pound of force at a working pressure of about 10,000 psi (test pressure of 15,000 psi). In one embodiment, the aperture 50 includes a tapped thread to engage setscrew 52. It should be known to those of skill in the art that the tapped thread of the invention is not critical.

In a specific embodiment, first thread 26 and second thread 28 are adapted to engage with one another such that rigid inner tube 20 is securely engaged in a selectable position relative to rigid outer tube 2 at a working pressure of abut 15,000 psi. In another specific embodiment, first thread 26 and second thread 28 are adapted to engage with one another such that rigid inner tube 20 is securely engaged in a selectable position relative to rigid outer tube 2 at a working pressure in the range of about 10,000-20,000 psi.

Outer wall 32 of rigid inner tube 20 has an O-ring sealing surface thereupon. The O-ring sealing surface engages with the at least one O-ring 60 seated in peripheral ring grooves 14 to seal the interior of joint 1.

Inner wall 10 and outer wall 32 define at least one recess 40 adapted to allow adjustment of the selectable position. Recess 40 provides the space necessary for rigid inner tube 20 and rigid outer tube 2 to adjustably engage.

Any means 16, 38 for connecting joint 1 to any other component within the installation may be employed, including, but not limited to any high-pressure connector. In one specific embodiment, the high-pressure connector is a flange. In another specific embodiment, the high-pressure connector is a clamp. In yet another specific embodiment, the high-pressure connector is a union connection. In other embodiments the high-pressure connector is at least one of a 1002, 1502 or 2002 union connector. It should be noted that the first connector 16 and the second connector 38 need not be the same, but may be the same in accordance with particular embodiments.

In one particular embodiment, at least one connector 16, 38 includes a thread. In a more specific embodiment, at least one connector 16, 38 is a male threaded connection and at least one connector is a female connection. The next assembly, for example other tubing, or the attachment stub of a valve may have an external thread to be engaged by the threads in these particular embodiments.

In some specific embodiments, at least one of the connector 16, 38 further includes a seal ring disposed about its surface. The seal ring protects the secondary metal-to-metal seal from abrasion and corrosion while minimizing flow turbulence.

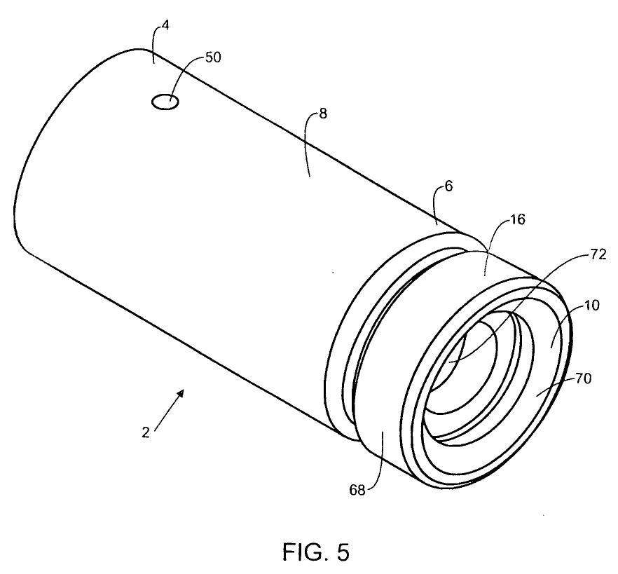

As illustrated in FIGS. 2-4, and in a further particular embodiment, at least one of the first connector 16 or the second connector 38 includes a shoulder 68 defining an enlargement 70, which is suitable for engagement by a next assembly, a passage 72 in contact with enlargement 70, passage 72 having a diameter approximately the same as the diameter of second passage 30, and a thread for connection of the next assembly to joint 1. As illustrated in FIGS. 2, 3 and 5, rigid inner tube 20 further includes a chamfer 74 about its second end 26 for engagement with connector 16. In this embodiment, the connector 16 is disposed about second end 26 of rigid outer tube 2.

In one specific embodiment, inner wall 10 of rigid outer tube 2 includes at least one means for catching debris 44. In an even more specific embodiment, the means for catching debris is a recess 44 adapted to catch debris caught within rigid inner tube 20 and rigid outer tube 2.

In a specific embodiment, joint 1 further includes a bleed port (not illustrated). The bleed port may be provided near one of the connector ends to enable pressure equalization between the environment and the interior passages, so that the discharge joint can be disconnected without fear of a sudden pressure release.

In many high-pressure assemblies, it may be necessary to use additional sealing mechanisms to strengthen the seal against fluid pressure. As such, and in one specific embodiment, at least one additional sealing means is seated within each of the at least one peripheral ring grooves 14 in inner wall 10 of rigid outer tube 2. In a more specific embodiment, the additional sealing means is a backup ring 42. The additional sealing means is simply seated along side of the O-ring 60 in the at least one peripheral ring groove 14.

In the specific embodiment illustrated in FIG. 1, the adjustable length joint 1 for high-pressure installations includes a rigid outer tube 2 that has a first end 4, central portion 8, and a second end 6. Rigid outer tube 2 has an inner wall 10 defining a first passage 12 that extends from first end 4 to second end 6. Rigid outer tube 2 has at least one peripheral ring groove 14 within inner wall 10 that is disposed about second end 6 of rigid outer tube 2. Inner wall 10 has a first thread 26 defined thereon, which is disposed about the central portion 8 of rigid outer tube 2. Joint 1 also includes a high-pressure connector 16 for connecting to a next assembly that is disposed about second end 6 of rigid outer tube 2. Rigid inner tube 20 has a first end 22, central portion 24, and a second end 26.

Rigid inner tube 20 includes an inner wall 28 defining a second passage 30 that extends from first end 22 to second end 26. Rigid inner tube 20 includes an outer wall 32 for communicating with the first passage 12, outer wall 32 having a second thread 28 defined thereon. First thread 26 and second thread 28 are adapted to securely engage with one another such that rigid inner tube 20 is securely engaged in a selectable position relative to rigid outer tube 2 at a working pressure of about 15,000 psi. Rigid inner tube 20 and rigid outer tube 2 are rotatable to enable adjustable engagement between first thread 26 and second thread 28. Outer wall 32 of rigid inner tube 20 has an O-ring sealing surface thereupon.

Rigid inner tube 20 further includes a high-pressure connector 38 for connecting to a next assembly disposed about first end 22 of rigid inner tube 20. The means for connecting 38 to a next component within the installation is disposed about first end 22 of rigid inner tube 20 or second end 6 of rigid outer tube 2, and may be any mechanism capable of connecting joint 1 to a next component within a high-pressure installation. In this specific embodiment, the connector 38 may include a shoulder 80 defining an enlargement 82, the enlargement 82 being suitable for engagement by a next assembly.

This embodiment of the joint 1 also includes at least one means 44 for limiting the adjustment of the selectable position within joint 1. Means 44 includes at least one of a setscrew 52, stop, screw, pin, shoulder 68 or a visual marking on the assembly. In a specific embodiment, means 44 includes a setscrew 52. In a more specific embodiment, means 44 further includes an aperture 50 including a tapped thread. The aperture 50 extends through inner wall 10 and outer wall 64 of rigid outer tube 2 for engagement by setscrew 52. Means 44 further includes a channel 54 defined by outer walls 32 of rigid inner tube 20, channel 54 being adapted to engage setscrew 52 thereby defining a range of adjustment for the selectable position.

This particular embodiment of joint 1 further includes at least one recess 40 adapted to allow adjustment of the selectable position, recess 40 being defined by inner wall 10 and outer wall 32 of rigid inner tube 20. The embodiment also includes a backup ring 42 and an O-ring 60 seated in each of the peripheral ring grooves 14. When rigid inner tube 20 and rigid outer tube 2 are held in the selectable position first thread 26 and second thread 28 overlap a sufficient distance necessary for first thread 26 and second thread 28 to withstand the forces exerted by internal pressure within joint 1 at the working pressure.

This embodiment may also include a bleed port (not shown in the Figures), at least one means for catching debris 44 in at least one of inner wall 10 or outer wall 32. As described above, rigid inner tube 20 may further include a chamfer 74 about its second end 26 for engagement with connector 16, which is disposed about second end 26.

In an even more specific embodiment, joint 1 includes a rigid outer tube 2 that has a first end 4, central portion 8, and a second end 6. Rigid outer tube 2 has an inner wall 10 that defines a first passage 12 that extends from first end 4 to second end 6 and at least one peripheral ring groove 14 within its inner wall 10. Groove 14 is disposed about second end 6 of rigid outer tube 2. Rigid outer tube 2 has a first thread 26 defined thereon, which is disposed about the central portion 8 of rigid outer tube 2. Second end 6 of rigid outer tube 2 has a high-pressure connector 16 for connecting to a next assembly. The high-pressure connector 16 is a male thread and further includes a seal ring that is removably disposed about the thread. Joint 1 also includes a rigid inner tube 20 that has a first end 22, a central portion 24 and a second end 26. Rigid inner tube 20 has an inner wall 28 that defines a second passage 30 that extends from first end 22 to second end 26. Rigid inner tube 20 includes an outer wall 32 for communicating with the first passage 12. Outer wall 32 of rigid inner tube 20 has a second thread 28 defined thereon, which is adapted to securely engage with first thread 26 of rigid outer tube 2 such that rigid inner tube 20 is securely engaged in a selectable position relative to rigid outer tube 2 at a working pressure of about 15,000 psi. Rigid inner tube 20 and rigid outer tube 2 are each rotatable to enable adjustable engagement between first thread 26 and second thread 28. Rigid inner tube 20 includes an O-ring sealing surface thereupon. First end 22 of rigid inner tube 20 has a high-pressure connector 38 for connecting to a next component within the high-pressure installation. Connector 38 includes a female thread. Joint 1 further includes at least one recess 40 for collecting debris in either inner wall 10 of rigid outer tube 2 or outer wall 32 of rigid inner tube 20. Joint 1 further includes a means 44 for limiting the adjustment of the selectable position within the joint 1. The means 44 includes a setscrew 52, and an aperture 50 that includes a tapped thread and extends through the inner and outer walls of rigid outer tube 2. Aperture 50 is for engagement by setscrew 54. The means 44 also includes a channel 54 defined by outer wall 32 of rigid inner tube 20, which is adapted to engage the setscrew 52 thereby defining a range of adjustment of the selectable position. Joint 1 further includes at least one recess 40, which is in place to allow adjustment of the selectable position. The range of the adjustment of the selectable position is ±0.5 inches. Inner wall 10 of rigid outer tube 2 and outer wall 32 of rigid inner tube 20 define the recess 40.

This particular embodiment further includes a backup ring 42 seated in each of the peripheral ring grooves 14, a bleed port about rigid outer tube 2, at least one recess 40 within inner wall 10 of rigid outer tube 2 for the collection of debris and an O-ring 60 seated in each of the peripheral ring grooves 14. When the inner and outer tubes are held in the selectable position, first thread 26 and second thread 28 are adapted to overlap a sufficient distance necessary for first thread 26 and second thread 28 to withstand the forces exerted by internal pressure within joint 1.

A method of manufacturing joint 1 is also provided that includes machining rigid outer tube 2, machining rigid inner tube 20, threading rigid inner tube 20 into rigid outer tube 2 to engage the first and second threads with an overlap of a sufficient distance necessary for the first thread 26 and the second thread 28 to withstand the forces exerted by internal pressure within the joint at the working pressure and placing a set screw 46 into an aperture 50 extending through outer wall 64 of the rigid outer tube 2 to engage a channel 54 defined by the outer wall 32 of rigid inner tube 20, thereby defining a range of adjustment for the selectable position of ±0.5 inches. Joint 1 is generally rough machined, heat or age-treated and finish-machined in particular embodiments.

Specific embodiments of the methods of manufacturing joint 1 described herein further include installing a bleed port in the rigid outer tube and seating an O-ring in each peripheral ring grooves 14.

While several preferred embodiments have been described for the purpose of this disclosure, numerous changes in the construction and arrangement of the parts can be made by those skilled in the art without departing from the spirit and scope of the invention as described by the claims that follow.

What is claimed is:

1. An adjustable length joint for high-pressure installations, the joint comprising:
a rigid outer tube having a first end, central portion, and a second end, the rigid outer tube having an inner wall defining a first passage extending from the first end to the second end, said outer tube having at least one peripheral ring groove within said inner wall, said at least one peripheral ring groove being disposed about the second end of the rigid outer tube, said inner wall having a first thread defined thereon, said first thread being disposed about the central portion of the rigid outer tube, and said second end of said rigid outer tube having connector for connecting with a next component within the high-pressure installation;
a rigid inner tube having a first end, central portion, and a second end, the rigid inner tube having an inner wall defining a second passage extending from the first end to the second end, the rigid inner tube having an outer wall having a second thread defined thereon, the first thread and second thread being adapted to securely engage with one another such that the rigid inner tube is securely engaged in a selectable position relative to said rigid outer tube at a working pressure of at least about 10,000 psi, the rigid inner tube and the rigid outer tube being rotatable to enable adjustable engagement between the first thread and second thread, and said outer wall having an O-ring sealing surface thereupon, said first end of said rigid inner tube having a second connector for connecting with another component within the high-pressure installation;
an adjustment limiter that limits the range of the selectable position; and
an O-ring seated in each of the at least one peripheral ring grooves;
wherein when the rigid inner tube and the rigid outer tube are held in the selectable position, the first thread and the second thread overlap a sufficient distance necessary for the first thread and second thread to withstand the forces exerted by internal pressure within the joint at the working pressure.

2. The joint of claim 1 wherein the rigid outer tube further comprises a bleed port.

3. The joint of claim 1 further comprising at least one means for collecting debris in at least one of the inner wall of the rigid outer tube or the outer wall of the rigid inner tube.

4. The joint of claim 1 wherein the first connector is a male connection and the second connector is a female connection.

5. The joint of claim 1 wherein the adjustment limiter comprises a setscrew, an aperture extending through the inner and outer walls of the rigid outer tube for engagement by the set screw, a channel defined by the outer walls of the rigid inner tube, the channel being adapted to engage the set screw thereby defining a range of adjustment for the selectable position.

6. The joint of claim 1 wherein the adjustment limiter comprises at least one of a set screw, stop, screw, pin, shoulder, or a visual marking on the assembly.

7. The joint of claim 1 further comprising at least one additional sealing means seated within each of the at least one peripheral ring grooves.

8. The joint of claim 7 wherein the at least one additional sealing means is a backup ring.

9. The joint of claim 1 wherein the first thread and second thread are adapted to engage with one another such that the rigid inner tube is securely engaged in a selectable position relative to said rigid outer tube at a working pressure of about 15,000 psi.

10. The joint of claim 1 wherein the first thread and the second thread are adapted to engage with one another such that the rigid inner tube is securely engaged in a selectable position relative to said rigid outer tube at a working pressure in the range of about 10,000-20,000 psi.

11. The joint of claim 1 wherein the rigid inner tube further comprises a chamfer about its second end for engagement with the connector, the connector being about the second end of the rigid outer tube.

12. The joint of claim 1 wherein each of the connector comprise a shoulder defining an enlargement, the enlargement being suitable for engagement by a next assembly, a passage in contact with the enlargement, the passage having a diameter approximately the same as the diameter of the second passage, and a thread for connection of the next assembly to the joint.

13. The joint of claim 1 wherein the adjustment limiter is adapted to limit the adjustment of the selectable position to ±0.5 inches.

14. An adjustable length joint for high-pressure installations, the joint comprising:
a rigid outer tube having a first end, central portion, and a second end, the rigid outer tube having an inner wall defining a first passage extending from the first end to the second end, said outer tube having at least one peripheral ring groove within said inner wall, said at least one peripheral ring groove being disposed about the second end of the rigid outer tube, said inner wall of the rigid outer tube having a first thread defined thereon, said first thread being disposed about the central portion of the rigid outer tube, and said second end of said rigid outer tube having a high pressure connector for connecting with a next component within the high-pressure installation;
a rigid inner tube having a first end, central portion, and a second end, the rigid inner tube having an inner wall defining a second passage extending from the first end to the second end, the rigid inner tube having an outer wall for communicating with said first passage, said outer wall of said rigid inner tube having a second thread defined thereon, the first thread and second thread being adapted to securely engage with one another such that the rigid inner tube is securely engaged in a selectable position relative to said rigid outer tube at a working pressure of about 15,000 psi, the rigid inner tube and the rigid outer tube being rotatable to enable adjustable engagement between the first thread and second thread in the selectable position, and said outer wall having an O-ring sealing surface thereupon, said first end of said rigid inner tube having a high pressure connector for connecting with a next component within the high-pressure installation;
at least one adjustment limiter in operational contact with at least one of the rigid inner tube, the rigid outer tube, or both, the means comprising at least one of a setscrew, stop, screw, pin, shoulder, or a visual marking on the assembly;
at least one recess adapted to allow adjustment of the selectable position, the recess being defined by the inner wall of the rigid outer tube and the outer wall of the rigid inner tube;
a backup ring seated in each of the at least one peripheral ring grooves; and
an O-ring seated in each of the at least one peripheral ring grooves;
whereby when the rigid inner tube and the rigid outer tube are held in the selectable position, the first thread and the second thread overlap a sufficient distance necessary for the first thread and the second thread to withstand the forces exerted by internal pressure within the joint at the working pressure.

15. The joint of claim 14 wherein the at least one adjustment limiter comprises a setscrew, an aperture having a tapped thread, the aperture extending through the inner and outer walls of the rigid outer tube for engagement by the setscrew, a channel defined by the outer walls of the rigid inner tube, the channel being adapted to engage the set screw thereby defining a range of adjustment for the selectable position.

16. The joint of claim 15 wherein the at least one of the first connector or the second connector further comprises a seal ring.

17. The joint of claim 15 wherein the rigid outer tube further comprises a bleed port.

18. The joint of claim 15 further comprising at least one means for catching debris in at least one of the inner wall of the rigid outer tube or the outer wall of the rigid inner tube.

19. The joint of claim 15 wherein the rigid inner tube further comprises a chamfer about its second end for engagement with the connector, the connector being about the second end of the rigid outer tube.

20. The joint of claim 15 wherein each of the connector comprise a shoulder defining an enlargement, the enlargement being suitable for engagement by a next assembly, a passage in contact with the enlargement, the passage having a diameter approximately the same as the diameter of the second passage, and a thread for connection of the next assembly to the joint.

21. A method of manufacturing an adjustable length joint for high-pressure installations, the method comprising:
machining a rigid outer tube having a first end, central portion, and a second end, the rigid outer tube having an inner wall defining a first passage extending from the first end to the second end, said outer tube having two peripheral ring grooves within said inner wall, said peripheral ring grooves being disposed about the second end of the rigid outer tube, said inner wall having a first thread defined thereon, said first thread being disposed about the central portion of the rigid outer tube, and said second end of said rigid outer tube having a high pressure connector for connecting with a next component within the high-pressure installation, the high pressure connector being a female thread;
machining a rigid inner tube having a first end, central portion, and a second end, the rigid inner tube having an inner wall defining a second passage extending from the first end to the second end, the rigid inner tube having an outer wall for communicating with said first passage, said outer wall having a second thread defined thereon, the first thread and the second thread being adapted to securely engage with one another such that the rigid inner tube is securely engaged in a selectable position relative to said rigid outer tube at a working pressure of about 15,000 psi, the rigid inner tube and the rigid outer tube being rotatable to enable adjustable engagement between the first thread and the second thread in the selectable position, and said outer wall having an O-ring sealing surface thereupon, said first end of said rigid inner tube having a high pressure connector for connecting with a next component within the high-pressure installation, the high pressure connection comprising a male thread;
threading the rigid inner tube into the rigid outer tube to engage the first and second threads with an overlap of a sufficient distance necessary for the first thread and the second thread to withstand the forces exerted by internal pressure within the joint at the working pressure; and
placing a set screw into an aperture extending through the outer wall of the rigid outer tube to engage a channel defined by the outer wall of the rigid inner tube, thereby defining a range of adjustment for the selectable position of ±0.5 inches.

22. The method of claim 21, further comprising:
installing a bleed port in the rigid outer tube; and
seating an O-ring in each of the at least one peripheral ring grooves.
